(19) United States
(12) Patent Application Publication
(10) Pub. No.: US 2007/0295842 A1
(43) Pub. Date: Dec. 27, 2007

(54) Rocking wastebasket or bin for paper shredder

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,672

(22) Filed: May 7, 2007

(30) Foreign Application Priority Data
Jun. 23, 2006 (TW) 095210988

(51) Int. Cl. B02C 23/00

(52) U.S. Cl. 241/100

(57) ABSTRACT

A rocking wastebasket or bin for paper shredder, including a machine body having cutting blades therein and a wastebasket or bin for containing paper chips, wherein the wastebasket or bin has a section of planar placement surface at a bottom thereof, and the planar placement surface is provided with arcuate faces between the planar placement surface and engagement portions at the bin walls, such that when the user rocks the wastebasket or bin forwards and backwards, or sideways, the chips in the chip mountain accumulated beneath the discharge port at the cutting blades can be spread outwards, so as to increase the space for receiving the paper chips in the wastebasket or bin, and to prevent the “chip mountain” from impeding smooth falling of subsequent paper chips, thereby eliminating the defects of affecting overall operative functions of the paper shredders.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to an improved wastebasket or bin for a paper shredder, particularly to one having an improved rocking wastebasket or bin for overcoming the problems caused by chip mountain formed by paper chips accumulated beneath the discharge port at the cutting blades of the paper shredder, which may impede smooth falling of subsequent paper chips, thereby affecting overall operative functions of the paper shredder.

2. Background

The conventional shredders for cutting paper use a plurality of cutting blades and spacers engaging over a rotary shaft, and the shearing force that two parallel and opposite rotary shafts produced by a motor and a gear box for transferring and cutting the paper-to-be-cut along a longitudinal direction into strips. Shredders can be classed into two types, the stripe-cut shredders and crosscut shredders, according to the machine cutting style. The former shredders arrange cutting blades to the rotating shafts in a manner to cutting the paper in a longitudinal direction to form strips. The later shredders include blades that include more than one cutting edge part, and each cutter is disposed helically along the rotary shaft for first cutting paper along a horizontal direction into strips and then cutting paper along a longitudinal direction into approximate 4 mm×40 mm paper chips. Regardless of being stripe-cut shredders and crosscut shredders, a basket or bin for containing paper chips usually accompanies the shredder at sales.

Regardless of stripe-cut shredders and crosscut shredders, a wastebasket or bin for containing paper chips is usually accompanied with the paper shredder on sales. As stated, the cutting blades engaging over a rotary shaft, and the shearing force that two parallel and opposite rotary shafts produced by a motor and a gear box serve to transfer and cut the paper-to-be-cut along a longitudinal direction into strips or chips, which are then dropped into the [symbol] wastebasket or bin through a discharge port located at a bottom of the paper shredder. Along with the increasing amount of chips, the paper chips would gradually accumulate to from a chip mountain. When the chip mountain has reached a height that is close to the discharge port of the paper shredder, it may impede smooth falling of subsequent paper chips, or even cause the paper chips to be drawn into the rotary shafts and jamming the gaps between the cutting blades, thereby affecting overall operative functions of the paper shredders.

Experiences show that, upon forming a “chip mountain,” the user only needs to spreading the mountain-like chips outwards to increase the space for receiving the paper chips in the wastebasket or bin, to prevent the “chip mountain” from impeding smooth falling of subsequent paper chips, or causing the paper chips to be drawn into the rotary shafts and jamming the gaps between the cutting blades, thereby affecting overall operative functions of the paper shredders.

### SUMMARY OF INVENTION

It is a primary object of this invention to provide the user with a way for spreading the “paper mountain” accumulated beneath the discharge port of the paper shredder outwards by simply rocking the wastebasket or bin so as to overcome the problems caused by paper chips that are impeded from smooth falling, or drawn into the rotary shafts and jam the gaps between the cutting blades, thereby affecting overall operative functions of the paper shredders.

It is another object of this invention to provide the user with a way for spreading the “paper mountain” accumulated beneath the discharge port of the paper shredder outwards by simply rocking the wastebasket or bin so as to increase the space for receiving the paper chips in the wastebasket or bin.

To achieve the above objects, this invention provides a wastebasket or bin having a section of planar placement surface at a bottom thereof. The planar placement surface is provided with arcuate faces between the planar placement surface and engagement portions at the bin walls, such that when the user rocks the wastebasket or bin forwards and backwards, or sideways, the chips in the chip mountain accumulated beneath the discharge port at the cutting blades can be spread outwards, so as to increase the space for receiving the paper chips in the wastebasket or bin, and to prevent the “chip mountain” from impeding smooth falling of subsequent paper chips, thereby eliminating the defects of affecting overall operative functions of the paper shredders.

### BRIEF DESCRIPTION OF THE DRAWINGS

These and other modifications and advantages will become even more apparent from the following detained description of a preferred embodiment of the invention and from the drawings in which:

FIG. 1 is a perspective schematic view illustrating the paper shredder of this invention;

FIG. 2 is a schematic view illustrating the wastebasket or bin of this invention rocking forwards and backwards; and

FIG. 3 schematic view illustrating the wastebasket or bin of this invention rocking sidewaysasket.

### DETAILED DESCRIPTION OF THE INVENTION (PREFERRED EMBODIMENTS)

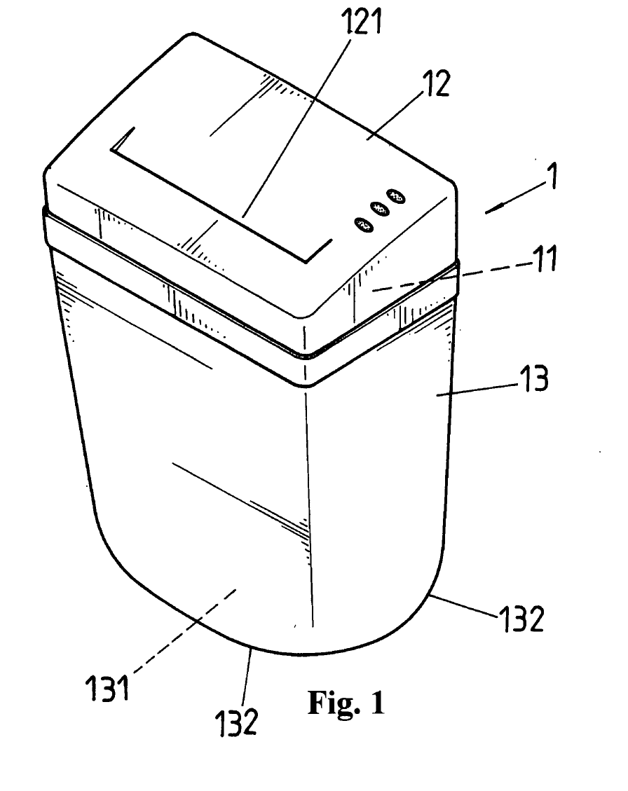

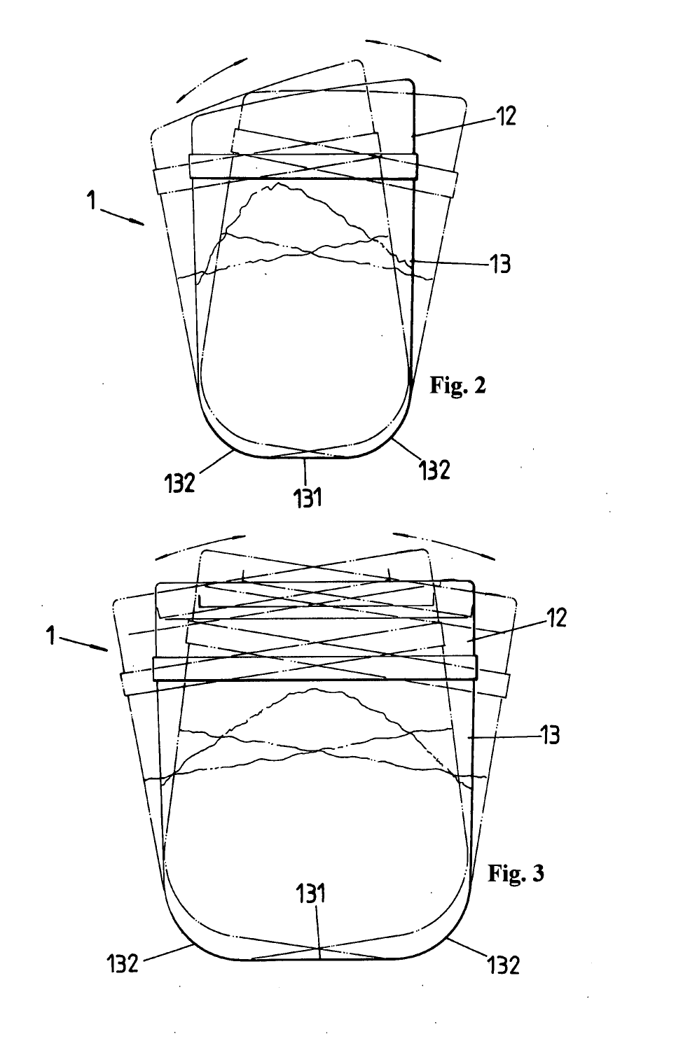

With reference to the drawings, FIG. 1 is a perspective schematic view illustrating the paper shredder of this invention; FIG. 2 is a schematic view illustrating the wastebasket or bin of this invention rocking forwards and backwards; and FIG. 3 schematic view illustrating the wastebasket or bin of this invention rocking sidewaysasket.

In the drawings, paper shredder 1 of this invention includes a machine body 12 having cutting blades 11 therein and a wastebasket or bin 13 for containing paper chips. The cutting blades engage over a rotary shaft, and the shearing force that two parallel and opposite rotary shafts produce by a motor and a gear box serve to transfer and cut the paper-to-be-cut along a longitudinal direction into strips, or further shredded in chips. The machine body 12 is provided at its surface with a paper inlet 121 parallel to the cutting blades, so as to guide the paper into the rotary shafts of the cutting blades 11 for shredding the paper.

In use, the machine body 12 and the cutting blades 11 straddled over the wastebasket or bin 13, where the wastebasket or bin 13 receives paper chips that are shredded by the cutting tools 11. This invention is characterized in that, the wastebasket or bin 13 has a section of planar placement surface 131 at a bottom thereof. The planar placement surface 131 is provided with arcuate faces 132 between the planar placement surface and engagement portions at the bin walls. The arcuate faces 132 are provided to at least one of the front side and back side of the wastebasket or bin 13, or to at least one of the left and right side of the wastebasket or bin 13, or to four sides of the front, back, left and right sides of the wastebasket or bin 13.

Accordingly, the user can rock the wastebasket or bin 13 at appropriate timing to rock the wastebasket or bin forwards and backwards, or sideways, for spreading the chips accumulated beneath the discharge port at the cutting blades outwards, so as to increase the space for receiving the paper chips in the wastebasket or bin, and to prevent the “chip mountain” from impeding smooth falling of subsequent paper chips, thereby eliminating the defects of affecting overall operative functions of the paper shredder.

In summary, this invention provides an improved paper shredder wastebasket that may not only serve as a wastebasket for containing paper shreds after the paper shredder shreds paper, but also be lifted outwards to serve as a conventional garbage bin, so as to improve the market competitiveness of the paper shredder by enhancing the functions of the wastebasket.

### LISTING OF NOMENCLATURES

1 paper shredder
11 cutting blades
12 machine body
121 paper inlet
13 wastebasket or bin
131 planar placement surface
132 arcuate faces

What is claimed is:

1. A rocking wastebasket or bin for paper shredder, including a set of cutting blades, a machine body encasing the cutting blades, and a wastebasket or bin for collecting paper chips, wherein the wastebasket or bin serves to receive paper chips shredded by the cutting blades, characterized in that: the wastebasket or bin has a section of planar placement surface at a bottom thereof, and the planar placement surface is provided with arcuate faces between the planar placement surface and engagement portions at the bin walls, such that when a user rocks the wastebasket or bin forwards and backwards, or sideways at appropriate timing, the chips accumulated beneath the discharge port at the cutting blades outwards are spread outwards so as to increase the space for receiving the paper chips in the wastebasket or bin, and to prevent formation of a chip mountain that impede smooth falling of subsequent paper chips, thereby preventing from affecting overall operative functions of the paper shredder.

2. The rocking wastebasket or bin for paper shredder of claim 1, wherein the arcuate faces are provided to one of the front side and back side of the wastebasket or bin.

3. The rocking wastebasket or bin for paper shredder of claim 1, wherein the arcuate faces are provided to both of the front side and back side of the wastebasket or bin.

4. The rocking wastebasket or bin for paper shredder of claim 1, wherein the arcuate faces are provided to one of the left side and right back side of the wastebasket or bin.

5. The rocking wastebasket or bin for paper shredder of claim 1, wherein the arcuate faces are provided to both of the left side and right back side of the wastebasket or bin.

6. The rocking wastebasket or bin for paper shredder of claim 1, wherein the arcuate faces are provided to the front side, back side, left side and right side of the wastebasket or bin.
